(19) United States
(12) Patent Application Publication
(10) Pub. No.: US 2019/0063634 A1
(43) Pub. Date: Feb. 28, 2019

(54) HYDRAULIC CONTROL DEVICE

(71) Applicant: NIDEC TOSOK CORPORATION, Kanagawa (JP)

(72) Inventor: Saori NUIYA, Kanagawa (JP)

(73) Assignee: NIDEC TOSOK CORPORATION, Kanagawa (JP)

(21) Appl. No.: 16/114,262

(22) Filed: Aug. 28, 2018

(30) Foreign Application Priority Data
Aug. 29, 2017 (JP) 2017-163933

(51) Int. Cl. F16K 31/06; F01L 1/344; F16K 11/07; F16H 61/06

(52) U.S. Cl. CPC F16K 31/0613; F01L 1/3442; F01L 2001/34426; F16H 61/067; F16K 11/0716

(57) ABSTRACT

Provided is a hydraulic control device having a valve member wherein the valve member includes a cylindrical sleeve including a first end and a second end which is opposite side to the first end, a valve body which is disposed on the second end side of a hollow portion in the cylindrical sleeve and opens and closes an oil path, a movable member which is disposed on the first end side in the hollow portion, movably accommodated along the hollow portion, and includes a pressure receiving surface provided to receive a hydraulic pressure and a contact portion provided to be brought into contact with the valve body according to the hydraulic pressure on the pressure receiving surface, and a movement stopping member which is disposed between the valve body and the second end and limits movement of the valve body toward the first end side within a predetermined range.

### CROSS-REFERENCE TO RELATED APPLICATION

This application claims the priority of Japan patent application serial no. 2017-163933, filed on Aug. 29, 2017. The entirety of the above-mentioned patent application is hereby incorporated by reference herein and made a part of this specification.

### BACKGROUND

### Technical Field

The disclosure relates to a hydraulic control device.

### Description of Related Art

A hydraulic control device including a valve member such as a ball valve is widely used for, for example, a hydraulic supply mechanism of a vehicle. The ball valve is constituted by disposing a ball serving as a valve body in a hollow sleeve in which an open end is provided. For example, Japanese Unexamined Patent Publication No. 2016-194356 discloses a hydraulic supply mechanism applied to a vehicle in which automatic stop control of an engine is performed and including an accumulator. This hydraulic supply mechanism performs control so that a working oil flows into the accumulator through the open end of the ball valve and is accumulated therein until a predetermined stop condition is satisfied and the engine is stopped. Further, a hydraulic supply mechanism of Japanese Unexamined Patent Publication No. 2016-194356 is controlled to push up the ball to open the valve of the ball valve when the predetermined stop condition is satisfied, to release a hydraulic pressure accumulated in the accumulator via the open end of the ball valve and to apply a pressure to a forward clutch.

However, in the conventional hydraulic control devices, a valve member is accommodated in a case having a stacked structure in which an oil path is provided corresponding to a port of the valve member. That is, a concave portion is provided in each of opposing portions of an upper layer and a lower layer of the case, and the valve member is accommodated in an accommodating space formed by the concave portions of the upper layer and the lower layer of the case. In assembling and manufacturing the hydraulic control device, the valve member is inserted into the concave portion of the lower layer of the case, and then the upper layer of the case is disposed to be superimposed on the lower layer of the case so that the valve member is accommodated in the concave portion of the upper layer of the case. When the valve member is inserted into the concave portion of the case, a movable member in the hollow sleeve may be separated from the open end of the hollow sleeve of the valve member.

It is therefore an objective of the disclosure to prevent a movable member from being separated from a hollow sleeve of a valve member during manufacture of a hydraulic control device including the valve member.

### SUMMARY

In an exemplary first embodiment of the present application, there is provided a hydraulic control device which includes a first main body having a first oil path therein and having a first concave portion communicating with the first oil path from a first opening in an outer surface thereof, a second main body having a second oil path therein and having a second concave portion communicating with the second oil path from a second opening in an outer surface thereof, and a columnar valve member, wherein the valve member is accommodated in an accommodating space in which the first opening and the second opening face each other and which is formed by the first concave portion and the second concave portion, and in which the first main body and the second main body are disposed, and the valve member includes a cylindrical sleeve including a first end which is an end having a third opening communicating with the first oil path, a second end which is an end having a fourth opening communicating with the second oil path and being opposite side to the first end, and a hollow portion provided between the first end and the second end, a valve body which is disposed on the second end side of the hollow portion and opens and closes a third oil path forming the hollow portion on the second end side, a movable member which is disposed on the first end side in the hollow portion, movably accommodated along the hollow portion, and includes a pressure receiving surface provided on the first end side to receive a hydraulic pressure from the first oil path and a contact portion provided on the second end side to be brought into contact with the valve body according to the hydraulic pressure on the pressure receiving surface, and a movement stopping member which is disposed between the pressure receiving surface and the first end having the third opening and limits movement of the movable member toward the first end side within a predetermined range.

The above and other elements, features, steps, characteristics and advantages of the disclosure will become more apparent from the following detailed description of the embodiments with reference to the attached drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an exploded perspective view of a hydraulic control device according to an embodiment.

FIG. 2 is a cross-sectional view of the hydraulic control device according to the embodiment.

FIG. 3 is a perspective view of a valve member.

FIG. 4 is a perspective view of the valve member.

FIG. 5 is an exploded perspective view of a part of components of the valve member.

FIG. 6 is a partially enlarged exploded perspective view of a part of the components of the valve member.

FIG. 7 is a top view of the valve member included in the hydraulic control device of the embodiment.

FIG. 8a is a diagram showing a first state of an input/output port of the valve member.

FIG. 8b is a diagram showing a second state of the input/output port of the valve member.

FIG. 9a is a view showing a valve member according to a modified example.

FIG. 9b is a cross-sectional view of the valve member shown in FIG. 9a.

### DESCRIPTION OF THE EMBODIMENTS

An embodiment of a hydraulic control device of the disclosure will be described below. Hereinafter, as one embodiment of the hydraulic control device of the disclosure, a case in which the hydraulic control device of the embodiment is applied to a vehicle performing automatic stop control of an engine and incorporated in a hydraulic supply mechanism having an accumulator will be described, but the application of the hydraulic control device of the disclosure is not limited thereto.

### (1) Configuration of Hydraulic Control Device 1 According to the Embodiment

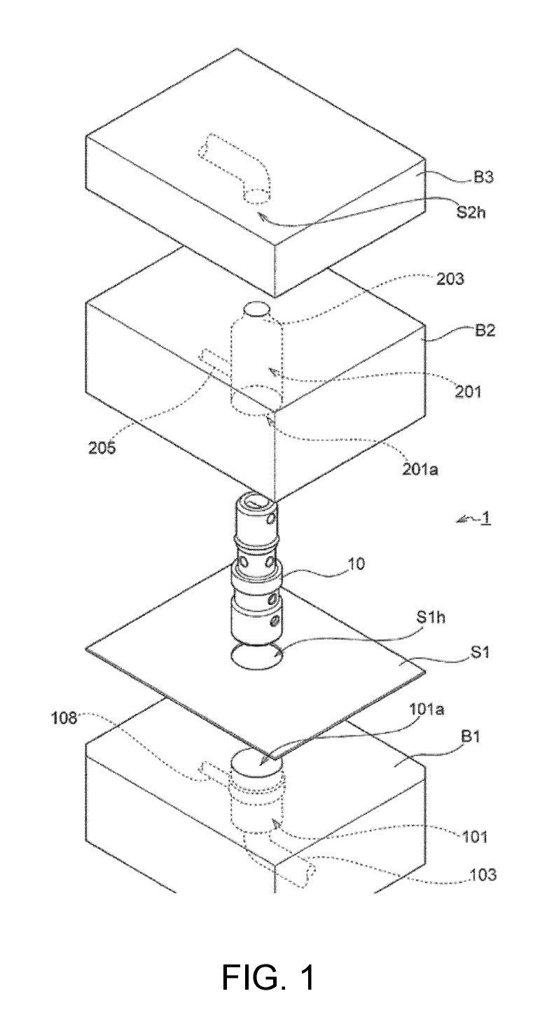

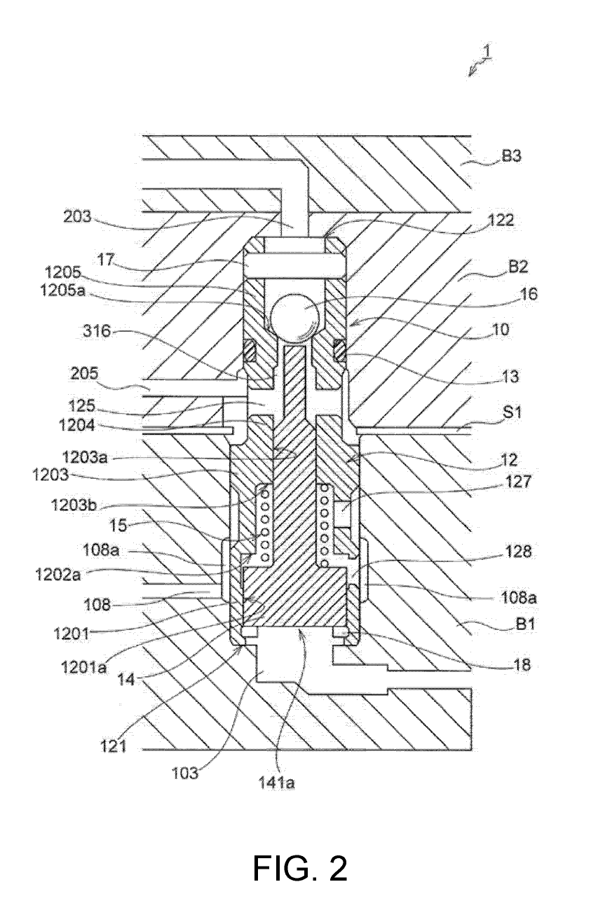

Hereinafter, a configuration of a hydraulic control device 1 of the embodiment will be described with reference to FIGS. 1 and 2. FIG. 1 is an exploded perspective view of the hydraulic control device 1 according to an embodiment. FIG. 2 is a cross-sectional view of the hydraulic control device 1 according to the embodiment.

As shown in FIGS. 1 and 2, the hydraulic control device 1 of the embodiment is configured by stacking a plurality of main bodies (a first main body B1, a second main body B2, and a third main body B3) as a whole, and a columnar valve member 10 is incorporated in the plurality of main bodies. That is, the hydraulic control device 1 includes the first main body B1, the second main body B2, a third main body B3, and a columnar valve member 10.

An oil path is provided in the plurality of main bodies B1 to B3, and the oil path communicates with an input/output port of the valve member 10. As shown in FIG. 2, the valve member 10 is a ball valve having a spherical valve body 16. That is, there is a configuration in which working oil flowing through the plurality of main bodies B1 to B3 communicates or does not communicate with the valve member 10 due to an operation of opening or closing the valve body 16.

More specifically, in FIG. 2, the hydraulic control device 1 has a stacked structure of a first main body B1 which is a lower layer, a second main body B2 of an upper layer, and a third main body B3 of an uppermost layer. Each of the main bodies is a die-cast member of a metal such as aluminum.

A separate plate S1 is provided between the first main body B1 and the second main body B2. The separate plate S1 is a flat plate formed of, for example, iron, or the like and provides a sealing function between adjacent main bodies. A circular hole S1h for disposing the valve member 10 is provided in the separate plate S1.

The separate plate is not provided between the second main body B2 and the third main body B3, but a separate plate may be provided to provide an additional sealing function.

In FIG. 1, the first main body B1, the second main body B2, and the third body B3 are formed in a rectangular parallelepiped shape but are not limited thereto. A shape of each of the main bodies can be appropriately modified according to an exterior required in the hydraulic control device 1.

As shown in FIG. 1, the first main body B1 has an oil path 103 therein and has a first concave portion 101 communicating with the oil path 103 from a first opening 101a in an outer surface thereof. The second main body B2 has an oil path 203 therein and has a second concave portion 201 communicating with the oil path 203 from a second opening 201a in an outer surface.

The oil path 103 is an example of a first oil path, and the oil path 203 is an example of a second oil path.

In a state in which the main bodies are stacked and assembled, the first main body B1 and the second main body B2 are disposed so that the first opening 101a and the second opening 201a face each other and the valve member 10 is accommodated in an accommodating space formed by the first concave portion 101 and the second concave portion 201. That is, the circular first opening 101a, the circular second opening 201a, and the circular hole S1h of the separate plate S1 overlap each other vertically in FIG. 2 and are aligned. In this state, the valve member 10 is accommodated in a cylindrical accommodating space formed by the first concave portion 101, the circular hole S1h, and the second concave portion 201. An diameter of the first opening 101a and a diameter of the second opening 201a are substantially the same as an outer diameter of a corresponding portion (a first cylindrical portion 1201 and a third cylindrical portion 1203 which will be described later) of the cylindrical valve member 10. The circular hole S1h of the separate plate S1 has a diameter slightly larger than an outer diameter of the first cylindrical portion 1201 and the third cylindrical portion 1203 such that it does not interfere with the first cylindrical portion 1201 and the third cylindrical portion 1203 of the valve member 10.

### (2) Configuration of the Valve Member 10

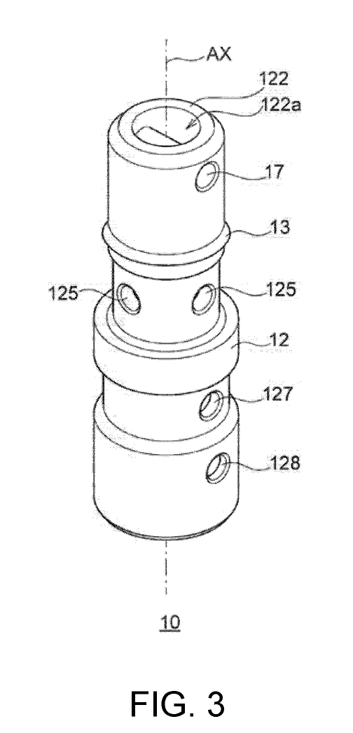

Next, the configuration of the valve member 10 incorporated in the hydraulic control device 1 of the embodiment will be described with reference to FIGS. 3 to 7.

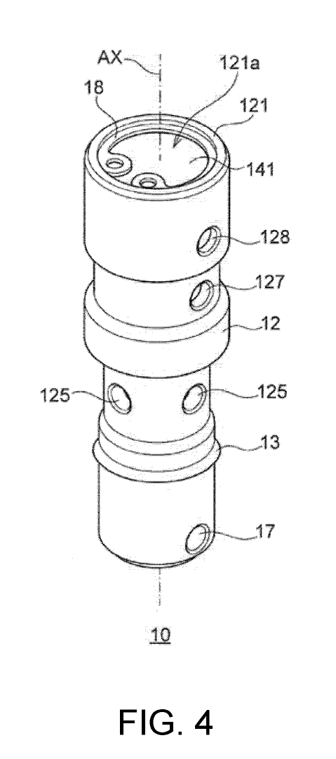

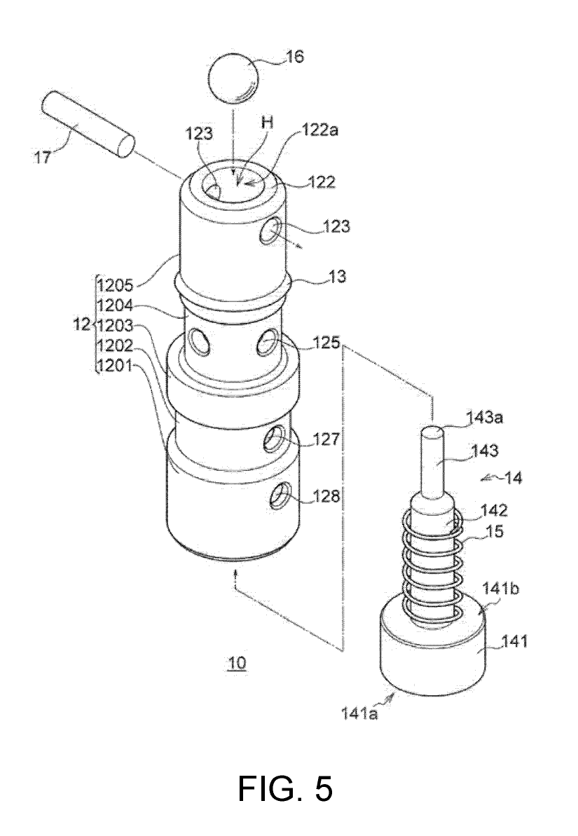

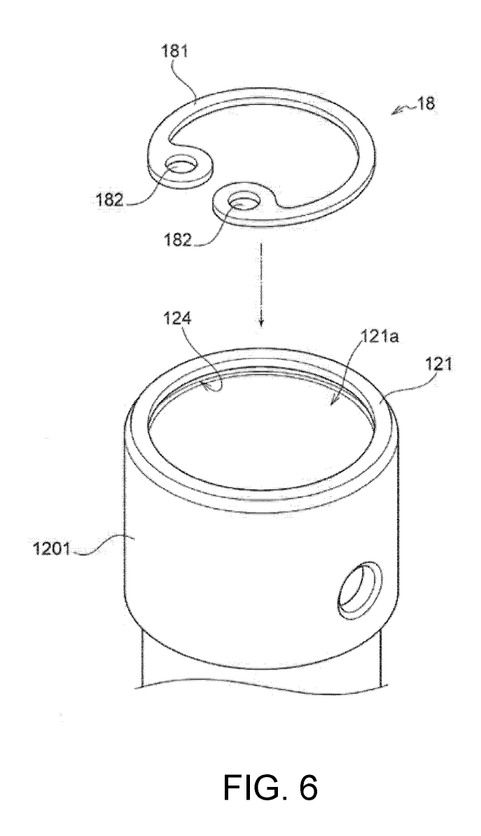

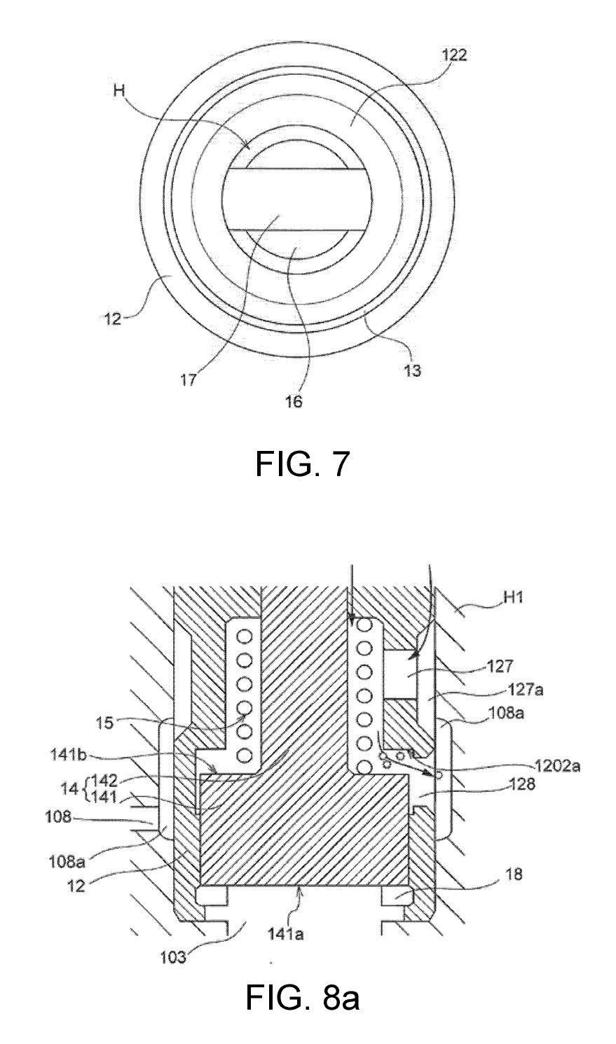

FIG. 3 is a perspective view of the valve member 10. FIG. 4 is a perspective view of the valve member 10 when seen from a different viewpoint from FIG. 3. FIG. 5 is an exploded perspective view of a part of components of the valve member 10 and is a view when seen from the same viewpoint as FIG. 3. FIG. 6 is a partial enlarged exploded perspective view of a part of the components of the valve member 10 and is a view when seen from the same viewpoint as FIG. 4. FIG. 7 is a top view of the valve member 10.

As shown in FIGS. 3 and 4, the valve member 10 has a cylindrical shape as a whole, and a plurality of input/output ports 125, 127 and 128 are provided. As shown in FIG. 2, the input/output port 125 communicates with an oil path 205 of the second main body B2, and the input/output port 128 communicates with an oil path 108 of the first main body B1.

In the following description, an axial direction is a direction along a central axis AX in a lengthwise direction of the valve member 10. The axial direction is the same as a vertical direction in FIG. 2. The central axis AX is the same as a lengthwise central axis of a cylindrical sleeve 12 which will be described later.

A circumferential direction of an inner circumferential wall of the cylindrical sleeve 12 is a direction along an inner circumferential wall surface of the cylindrical sleeve 12 on a virtual plane orthogonal to the central axis AX. The circumferential direction of an outer circumferential wall of the cylindrical sleeve 12 is a direction along an outer circumferential wall surface of the cylindrical sleeve 12 on the virtual plane orthogonal to the central axis AX.

As shown in FIGS. 5 and 6, the valve member 10 includes the cylindrical sleeve 12, an O-ring 13, a movable member 14, a coil spring 15, the valve body 16, a pin 17, a C-shaped ring 18 (an example of a movement stopping member).

The cylindrical sleeve 12 includes a first end 121 which is an end having a third opening 121a communicating with the oil path 103, and a second end 122 which is an end having a fourth opening 122a communicating with the oil path 203 and being opposite side to the first end 121, and also includes a hollow portion H between the first end 121 and the second end 122.

As shown in FIG. 5, the cylindrical sleeve 12 includes the first cylindrical portion 1201, a second cylindrical portion 1202, the third cylindrical portion 1203, a fourth cylindrical portion 1204, and a fifth cylindrical portion 1205. Outer diameters of the first cylindrical portion 1201 and the third cylindrical portion 1203 are larger than outer diameters of the second cylindrical portion 1202, the fourth cylindrical portion 1204, and the fifth cylindrical portion 1205.

The input/output port 128 which allows the hollow portion H to communicate with the oil path 108 (refer to FIG. 2) is provided in the first cylindrical portion 1201. An end of the first cylindrical portion 1201 is the first end 121 of the cylindrical sleeve 12. An inner diameter of the first cylindrical portion 1201 is substantially equal to an outer diameter of a first sliding portion 141 so that the first sliding portion 141 of the movable member 14 slides on an inner circumferential wall 1201a (refer to FIG. 2) of the first cylindrical portion 1201 when the movable member 14 moves in the hollow portion H.

The input/output port 127 which communicates with the hollow portion H is provided in the second cylindrical portion 1202. A stopper surface 1202a (refer to FIG. 2) is provided at a position on the second cylindrical portion 1202 which faces a spring seat surface 141b (described later) of the movable member 14 in the axial direction.

An inner diameter of the third cylindrical portion 1203 is substantially equal to an outer diameter of a second sliding portion 142 so that the second sliding portion 142 of the movable member 14 slides on an inner circumferential wall 1203a (refer to FIG. 2) of the third cylindrical portion 1203 when the movable member 14 moves in the hollow portion H. As shown in FIG. 2, a spring seat surface 1203b is provided at a position of the third cylindrical portion 1203 which faces the spring seat surface 141b (refer to FIG. 5) of the movable member 14 in the axial direction.

The input/output ports 125 (at four positions in the circumferential direction) which communicate the hollow portion H with the oil path 205 (refer to FIG. 2) are provided in the fourth cylindrical portion 1204.

Through-holes 123 (at two positions in the circumferential direction) through which the pin 17 passes are provided in the fifth cylindrical portion 1205. An end of the fifth cylindrical portion 1205 is the second end 122 of the cylindrical sleeve 12. As shown in FIG. 2, in the hollow portion H, a tapered valve seat surface 1205a is provided on the fifth cylindrical portion 1205.

A groove for disposing the O-ring 13 is provided in an outer circumferential wall of the fifth cylindrical portion 1205 in the circumferential direction. As shown in FIG. 2, the O-ring 13 is a member which seals between the oil path 205 and the oil path 203 of the second main body B2.

The movable member 14 is disposed on the first end 121 side in the hollow portion H and accommodated movably along the hollow portion H, and a pressure receiving surface 141a which receives a hydraulic pressure from the oil path 103 is provided on the first end 121 side thereof, and a contact portion 143a which can be brought into contact with the valve body 16 according to the hydraulic pressure of the pressure receiving surface 141a is provided on the second end 122 side thereof.

As shown in FIG. 5, the movable member 14 includes the first sliding portion 141 which is a large diameter column portion from one side to the other in the axial direction, the second sliding portion 142 which is a cylindrical portion having a diameter smaller than that of the first sliding portion 141, and a tip portion 143 which is a cylindrical portion having a diameter smaller than that of the second sliding portion 142.

A bottom surface of the first sliding portion 141 is the pressure receiving surface 141a. Since the pressure receiving surface 141a has a relatively large diameter, the hydraulic pressure from the oil path 103 can be converted into a force which efficiently moves the movable member 14 in the axial direction. When the movable member 14 moves in the axial direction, the first sliding portion 141 slides on the inner circumferential wall 1201a of the first cylindrical portion 1201, and the second sliding portion 142 slides on the inner circumferential wall 1203a of the third cylindrical portion 1203.

An upper surface of the tip portion 143 is the contact portion 143a. As shown in FIG. 2, an outer diameter of the tip portion 143 is determined so that an oil path 316 is provided between inner circumferential walls of the fourth cylindrical portion 1204 and the fifth cylindrical portion 1205. The oil path 316 is an example of a third oil path.

Further, an axial position of the contact portion 143a of the tip portion 143 is determined so that the contact portion 143a does not come into contact with the valve body 16 when the hydraulic pressure received by the pressure receiving surface 141a from the oil path 103 is low.

The coil spring 15 is disposed between the spring seat surface 141b which is an upper surface of the first sliding portion 141 of the movable member 14 and the spring seat surface 1203b (refer to FIG. 2) of the third cylindrical portion 1203. The coil spring 15 as a biasing member biases the movable member 14 toward the third opening 121a of the cylindrical sleeve 12 in the hollow portion H of the cylindrical sleeve 12. When the hydraulic pressure received by the pressure receiving surface 141a from the oil path 103 is low due to a biasing force of the coil spring 15, no force for moving the movable member 14 against the biasing force is generated.

The valve body 16 is disposed on the second end 122 side of the hollow portion H and opens and closes the oil path 316 (refer to FIG. 2) forming the hollow portion H on the second end 122 side. In the example of the embodiment, although the valve body 16 is spherical, the disclosure is not limited thereto and may have any form as long as the oil path 316 can be opened and closed. For example, instead of the valve body 16, it may be a valve body having an elliptical cross section or a valve body of a form like a bullet (a shape in which one side is tapered).

As shown in FIG. 2, the pin 17 is disposed between the valve body 16 and the second end 122 and limits movement of the valve body 16 toward the second end 122 within a predetermined range. In the example of the embodiment, the pin 17 is a cylindrical pin but is not limited thereto. As shown in FIG. 5, two through-holes 123 are provided in the circumferential wall of the fifth cylindrical portion 1205 of the cylindrical sleeve 12. The pin 17 is supported by the two through-holes 123 and is disposed to cross the hollow portion H of the cylindrical sleeve 12.

Further, as shown in FIG. 7, the pin 17 is installed in the cylindrical sleeve 12 to overlap with the valve body 16 when the valve member 10 is seen in a direction from the second end 122 toward the first end 121 (that is, in the axial direction). Therefore, the axial movement of the valve body 16 from the valve seat surface 1205a is limited until an apex of the spherical valve body 16 comes into contact with a surface of the pin 17 in FIG. 2.

According to an embodiment, the pin 17 is rotatably supported by the circumferential wall of the cylindrical sleeve 12. In this case, a position of the surface of the pin 17 with which the valve body 16 comes into contact when the valve member 10 operates is not concentrated at a specific position, and stress concentration in the pin 17 is avoided.

The C-shaped ring 18 is disposed between the pressure receiving surface 141a of the movable member 14 and the first end 121 having the third opening 121a and limits the movement of the movable member 14 toward the first end 121 within a predetermined range.

As shown in FIG. 6, a circumferential groove 124 is provided in the inner circumferential wall of the fifth cylindrical portion 1205 of the cylindrical sleeve 12, that is, at a position close to the first end 121. A diameter of the C-shaped ring 18 is reduced, and the C-shaped ring 18 is inserted into the groove 124, and in the groove 124, it is kept at a position of a bottom surface of the groove 124 by the biasing force acting in a direction in which the diameter expands. A part of the C-shaped ring 18 is supported within the groove 124, and a part thereof is in contact with a part of a circumferential edge of the pressure receiving surface 141a.

As shown in FIG. 6, the C-shaped ring 18 includes a C-shaped curved portion 181 and jig insertion holes 182 provided at both ends of the curved portion 181. That is, the jig insertion holes 182 for reducing the diameter to be smaller than the inner diameter of the cylindrical sleeve 12 at the position of the groove 124 are provided at both ends of the C-shaped ring 18. Workability when the C-shaped ring 18 is inserted into the groove 124 is improved by inserting a jig into the jig insertion hole 182 to reduce the diameter of the C-shaped ring 18. When the jig is not used, the jig insertion hole 182 may not be provided.

A part of the C-shaped ring 18 protrudes inward from the groove 124 after being inserted into the groove 124 and supports a part of the pressure receiving surface 141a of the cylindrical sleeve 12 in the axial direction. A protrusion amount may be appropriately set as long as it can support the cylindrical sleeve 12 in the axial direction. Since an axial thickness of the C-shaped ring 18 may be small, the C-shaped ring 18 has excellent space efficiency in the axial direction, and it is not necessary to greatly sacrifice the pressure receiving surface 141a.

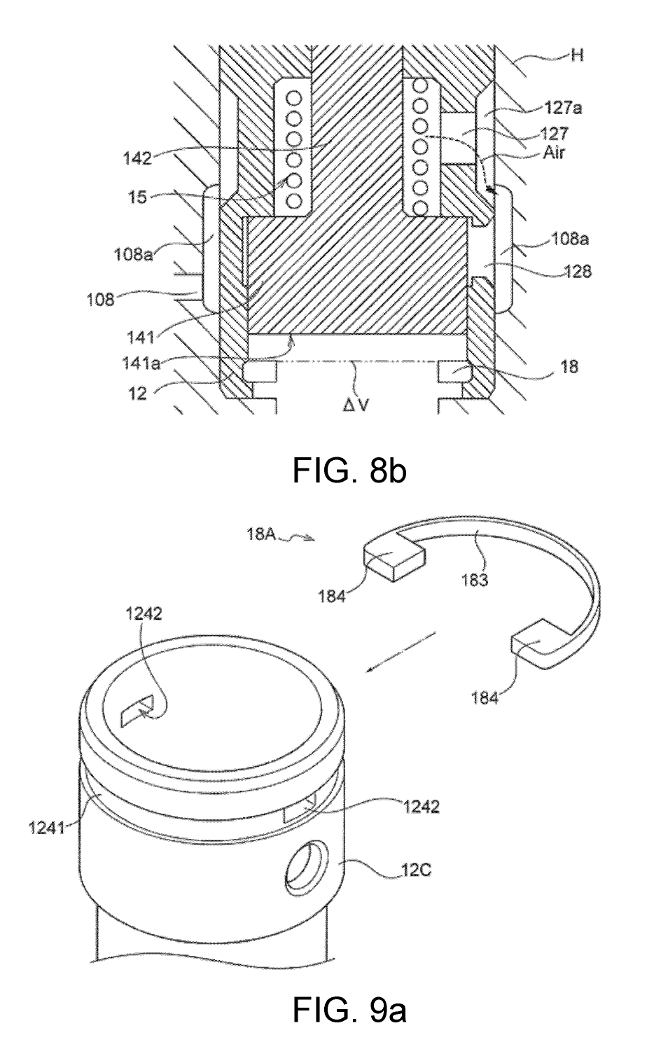

Next, the input/output ports 127 and 128 will be described with reference to FIG. 8a and FIG. 8b. FIGS. 8a and 8b are diagrams showing the input/output ports of the valve member 10, in which FIG. 8a is a partial cross-sectional view of the hydraulic control device 1 when the oil path 103 is at a low pressure and FIG. 8b is a partial cross-sectional view of the hydraulic control device 1 when the oil path 103 is at a high pressure.

The oil path 108 of the first main body B1 is a discharge path through which the working oil in the valve member 10 is discharged. As shown in the drawing, in the oil path 108, a groove 108a is provided in the circumferential direction of the outer circumferential wall of the cylindrical sleeve 12 at an end thereof communicating with the input/output port 128 of the valve member 10. The oil path 108 is on a side opposite to the input/output port 128 in the groove 108a in the circumferential direction and is connected to one end side in the axial direction. The groove 108a of the oil path 108 is provided for a function of effectively discharging contaminants in the valve member 10 and a function of smoothing the operation of the valve member 10.

The function of effectively discharging contaminants in the valve member 10 is as follows.

When the oil path 103 is at a high pressure, since the pressure applied to the pressure receiving surface 141a is high, the movable member 14 is separated from the C-shaped ring 18 and the spring seat surface 141b is in contact with the stopper surface 1202a. Therefore, the contaminants in the valve member 10 are accumulated on the spring seat surface 141b due to gravity.

When the oil path 103 is at a low pressure, since the pressure applied to the pressure receiving surface 141a is low, the movable member 14 is in contact with the C-shaped ring 18. At this time, the working oil flowing downward from a gap between the inner circumferential wall of the cylindrical sleeve 12 and the second sliding portion 142 and a gap between the outer circumferential wall of the cylindrical sleeve 12 and the first main body B1 passes between the spring seat surface 141b of the first sliding portion 141 and the stopper surface 1202a of the cylindrical sleeve 12 and is guided to the groove 108a of the oil path 108. Accordingly, the contaminations accumulated on the spring seat surface 141b move along the groove 108a together with the working oil in the circumferential direction and are discharged without remaining in the groove 108a from the oil path 108 connected to one side of the groove 108a in the axial direction.

The function of smoothing the operation of the valve member 10 is as follows.

When the oil path 103 changes from a low pressure to a high pressure, the movable member 14 is pushed up by an amount corresponding to a predetermined volume (ΔV in FIG. 8b) inside the cylindrical sleeve 12. Therefore, when it is assumed that a mechanism for releasing pressure is not provided, the inside of the cylindrical sleeve 12 will be at a high pressure, and the smooth movement of the movable member 14 will be hindered. On the other hand, in the embodiment, as shown in FIGS. 8a and 8b, a port end 127a of the input/output port 127 is formed in a shape which expands from the hollow portion H of the cylindrical sleeve 12 toward the first main body B1, and the port end 127a and the groove 108a communicate with each other. Therefore, when the oil path 103 changes from a low pressure to a high pressure, as indicated by a dotted line in FIG. 8b, air in the cylindrical sleeve 12 moves from the port end 127a of the input/output port 127 to the groove 108a, thereby minimizing the high pressure inside the cylindrical sleeve 12. In an embodiment, the volume of the groove 108a is larger than the above ΔV.

### (3) Operation of Valve Member 10 in Hydraulic Control Device 1 of the Embodiment

Next, the operation of the valve member 10 in the hydraulic control device 1 of the embodiment will be described.

As described above, the hydraulic control device 1 of the embodiment is incorporated in a hydraulic supply mechanism having an accumulator applied to a vehicle which performs automatic stop control of an engine.

In the hydraulic supply mechanism, an operation of accumulating in the accumulator (not shown) is performed until a predetermined stop condition is satisfied and the engine is stopped. The oil path 203 of the hydraulic control device 1 communicates with the accumulator. When the operation of accumulating in the accumulator is performed, the pressure of the accumulator is set to be lower than that in the oil path 205. Therefore, the valve body 16 is pushed up via the oil path 316 by the pressure of the working oil flowing through the oil path 205, and the working oil flows into the accumulator via the fourth opening 122a and the oil passage 203 and is accumulated.

Then, when the predetermined stopping condition is satisfied, the pressure of the oil path 103 of the hydraulic control device 1 is controlled to rise. Therefore, the movable member 14 of the valve member 10 is pushed up against the biasing force of the coil spring 15 by the hydraulic pressure received by the pressure receiving surface 141a of the movable member 14, and thus the contact portion 143a of the movable member 14 pushes up the valve body 16 and opens the oil path 316. As a result, the working oil accumulated in the accumulator flows backward and flows to the oil path 205 via the oil path 203, the fourth opening 122a, the oil path 316, and the input/output port 125. The hydraulic pressure of the working oil accumulated in the accumulator communicates with the forward clutch through an oil path (not shown), thereby making it possible to smoothly start the vehicle.

In the embodiment, when the contact portion 143a of the movable member 14 pushes up the valve body 16, since the pin 17 is disposed above the valve body 16 as shown in FIG. 2, the valve body 16 is prevented from colliding with the second main body B2. Therefore, occurrence of the contaminations due to the operation of the hydraulic control device 1 can be minimized.

### (4) Assembling Method of Hydraulic Control Device 1 of the Embodiment

Next, a method of assembling the hydraulic control device 1 of the embodiment will be described with reference to FIGS. 1, 5, and 6.

First, in assembling the valve member 10, as shown in FIG. 5, the O-ring 13 is installed at the cylindrical sleeve 12, the valve body 16 is accommodated in the hollow portion H of the cylindrical sleeve 12, and then the pin 17 is inserted into the through-hole 123. Then, the cylindrical sleeve 12 including the valve body 16 is turned over, and the cylindrical sleeve 12 is disposed so that the first end 121 faces upward as shown in FIG. 6. The movable member 14 in which the coil spring 15 is installed is inserted into the hollow portion H of the cylindrical sleeve 12 from the third opening 121a of the first end 121. Finally, the valve member 10 is completed by fitting the C-shaped ring 18 into the groove 124 while reducing the diameter thereof using the jig.

Next, as shown in FIG. 1, the first main body B1 is disposed on a plane, and the separate plate 51 is disposed on the upper surface of the first main body B1 while the circular hole S1h and the first opening 101a are aligned with each other. Then, the valve member 10 is inserted into the first concave portion 101 from the first end 121 side through the circular hole S1h and the first opening 101a. Thereafter, the second main body B2 is disposed on the separate plate S1 such that the second end 122 side of the valve member 10 is inserted into the second concave portion 201. Finally, the hydraulic control device 1 is completed by disposing the third main body B3 on the second main body B2 and connecting the first main body B1, the second main body B2, and the third main body B3 by a fastening unit (not shown).

In the valve member 10 of the embodiment, since the pin 17 is disposed above the valve body 16, the pin 17 functions as a stopper of the valve body 16 in the process of assembling the hydraulic control device 1, and the valve body 16 is prevented from being separated from the fourth opening 122a of the second end 122 of the cylindrical sleeve 12.

Further, in the valve member 10 of the embodiment, since the C-shaped ring 18 is disposed between the pressure receiving surface 141a of the movable member 14 and the first end 121, the movable member 14 is prevented from being separated from the third opening 121a of the first end 121 in the process of assembling the hydraulic control device 1.

As described above, according to the hydraulic control device 1 of the embodiment, the pin 17 which limits the movement of the valve member 10 toward the second end 122 side within the predetermined range is provided. Therefore, it is possible to prevent the valve body 16 of the valve member 10 from being separated during the manufacturing of the hydraulic control device 1 including the valve member 10 and to minimize the occurrence of the contaminations due to the operation of the hydraulic control device 1.

Further, according to the hydraulic control device 1 of the embodiment, it is possible to prevent the movable member 14 of the valve member 10 from being separated during the manufacturing of the hydraulic control device 1 including the valve member 10 by disposing the C-shaped ring 18.

Although the embodiment of the hydraulic control device of the disclosure has been described above, the disclosure is not limited to the above embodiment. Further, various improvements and modifications can be made to the above-described embodiment within a range not deviating from the gist of the present invention.

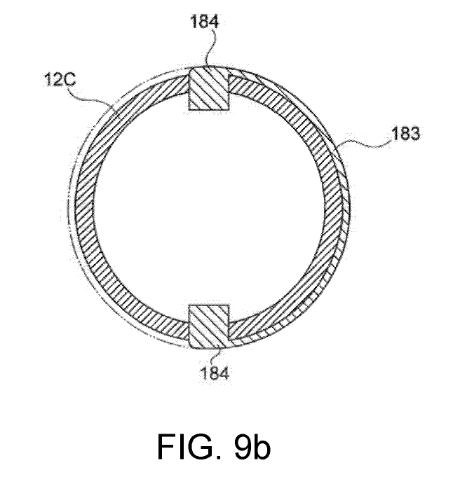

For example, in the above-described embodiment, as shown in FIG. 6, the case in which the circumferential groove 124 is provided in the inner circumferential wall at the position close to the first end 121 has been described, but the disclosure is not limited thereto. In the cylindrical sleeve 12, the circumferential groove may be provided in the outer circumferential surface at the position close to the first end 121, and modified examples in that case are shown in FIGS. 9a and 9b.

FIG. 9a is a partial enlarged exploded perspective view of a part of the components of the valve member according to a modified example similarly to FIG. 6. FIG. 9b is a cross-sectional view of a cylindrical sleeve 12C after the C-shaped ring 18A is installed, which is taken along a plane orthogonal to the axial direction in FIG. 9a .

As shown in FIG. 9a, in the modified example, a circumferential groove 1241 is provided in the outer circumferential surface at a position of the cylindrical sleeve 12C close to the first end. In the groove 1241, through-holes 1242 (two positions in the circumferential direction) passing through the hollow portion of the cylindrical sleeve 12C is provided.

In the modified example, the C-shaped ring 18A is installed at the cylindrical sleeve 12. The C-shaped ring 18A has a curved portion 183 and protruding portions 184 provided at both ends of the curved portion 183. The curved portion 183 is inserted along the groove 1241, and the protruding portions 184 on both sides are inserted into the two through-holes 1242. In a state in which the C-shaped ring 18A is installed at the cylindrical sleeve 12C, the outer circumferential surface of the curved portion 183 coincides with the outer circumferential surface of the cylindrical sleeve 12C as shown in FIG. 9b, and the protruding portions 184 protrude from the inner circumferential wall of the cylindrical sleeve 12C toward the hollow portion of the cylindrical sleeve 12C.

In the modified example, a C-shaped ring 18C as the movement stopping member is partially supported in the through-hole 1242 and partly comes into contact with a part of the circumferential edge of the pressure receiving surface of the movable member (not shown), and the movable member is prevented from being separated from the cylindrical sleeve 12C.

Features of the above-described embodiments and the modifications thereof may be combined appropriately as long as no conflict arises.

While embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A hydraulic control device which comprises a first main body having a first oil path therein and having a first concave portion communicating with the first oil path from a first opening in an outer surface thereof, a second main body having a second oil path therein and having a second concave portion communicating with the second oil path from a second opening in an outer surface thereof, and a columnar valve member,
wherein the valve member is accommodated in an accommodating space in which the first opening and the second opening face each other and which is formed by the first concave portion and the second concave portion, and in which the first main body and the second main body are disposed, and
the valve member comprises a cylindrical sleeve including a first end which is an end having a third opening communicating with the first oil path, a second end which is an end having a fourth opening communicating with the second oil path and being opposite side to the first end, and a hollow portion provided between the first end and the second end, a valve body which is disposed on the second end side of the hollow portion and opens and closes a third oil path forming the hollow portion on the second end side, a movable member which is disposed on the first end side in the hollow portion, movably accommodated along the hollow portion, and includes a pressure receiving surface provided on the first end side to receive a hydraulic pressure from the first oil path and a contact portion provided on the second end side to be brought into contact with the valve body according to the hydraulic pressure on the pressure receiving surface, and a movement stopping member which is disposed between the pressure receiving surface and the first end having the third opening and limits movement of the movable member toward the first end side within a predetermined range.

2. The hydraulic control device according to claim 1, wherein the cylindrical sleeve has a circumferential groove in an inner circumferential wall at a position close to the first end, and
a part of the movement stopping member is supported in the groove and a part thereof comes into contact with a part of a circumferential edge of the pressure receiving surface.

3. The hydraulic control device according to claim 2, wherein the movement stopping member is a C-shaped member, and a circumferential edge thereof is supported in the groove.

4. The hydraulic control device according to claim 3, wherein a jig insertion hole which reduces a diameter to be smaller than an inner diameter of the cylindrical sleeve at a position of the groove is provided at both ends of the C-shaped member.

5. The hydraulic control device according to claim 1, wherein the cylindrical sleeve has a circumferential groove in an outer circumferential surface at a position close to the first end, and a part of the movement stopping member is supported in the groove and a part thereof comes into contact with a part of a circumferential edge of the pressure receiving surface.

6. The hydraulic control device according to claim 1, further comprising a biasing member which biases the movable member toward the third opening in the hollow portion of the cylindrical sleeve.

7. The hydraulic control device according to claim 2, further comprising a biasing member which biases the movable member toward the third opening in the hollow portion of the cylindrical sleeve.

8. The hydraulic control device according to claim 3, further comprising a biasing member which biases the movable member toward the third opening in the hollow portion of the cylindrical sleeve.

9. The hydraulic control device according to claim 4, further comprising a biasing member which biases the movable member toward the third opening in the hollow portion of the cylindrical sleeve.

10. The hydraulic control device according to claim 5, further comprising a biasing member which biases the movable member toward the third opening in the hollow portion of the cylindrical sleeve.
